(19) United States
(12) Patent Application Publication
(10) Pub. No.: US 2013/0199882 A1
(43) Pub. Date: Aug. 8, 2013

(54) Pivot mechanism in a brake lever of bicycle for ensuring a reliable actuation of brake

(71) Applicant: Szu-Fang Tsai, Changhua (TW)

(72) Inventor: Szu-Fang Tsai, Changhua (TW)

(21) Appl. No.: 13/411,622

(22) Filed: Mar. 4, 2012

(30) Foreign Application Priority Data
Feb. 8, 2012 (TW) 101202257

(51) Int. Cl. B62L 3/02

(52) U.S. Cl. 188/344

(57) ABSTRACT

A bicycle brake operating device is provided with a housing on a handlebar and including a channel, first and second holes, a fluid reservoir, and a reservoir cover on the fluid reservoir; a brake transmission mechanism in the channel; a hydraulic brake lever including a stepped-diameter tunnel and a push member engaging the spring actuated mechanism; and a pivot assembly including a first retaining member including a sleeve disposed in the first hole and having one end engaging the reservoir cover, and an annular flange at the other end of the sleeve and engaging an inner surface of the tunnel; a second retaining member including a cup in the second hole and having a bottom through hole, and an annular flange around mouth of the cup, the flange engaging the inner surface of the tunnel; and a cylindrical pivot in the first and second retaining members and the tunnel.

### BACKGROUND OF THE INVENTION

1. Field of the Invention

The invention relates to bicycle brake and more particularly to a pivot mechanism in a brake lever of bicycle for ensuring a reliable actuation of the brake.

2. Description of Related Art

A conventional brake operating device for bicycles comprises a housing mounted in the vicinity of a grip of a handlebar, a hydraulic brake lever rotatably supported on the housing through a cylindrical, stepped diameter pivot provided through two opposite holes spaced by a bifurcated opening, a fluid reservoir disposed in the housing, and a reservoir cover releasably secured to the fluid reservoir.

The brake operating device further comprises a spring actuated brake transmission mechanism provided in a cylindrical channel in the housing. The brake transmission mechanism comprises a stepped-diameter piston in a hydraulic cylinder which communicates brake fluid with the fluid reservoir, two opposite ring members put on the piston, a return spring biasing between one end of the piston and an inner surface of the hydraulic cylinder, and a threaded push rod having one end pushing the piston via a C-ring and a washer. A threaded fastener having one end engaged with the other end of the push rod and the other end disposed in one of three portions of a tunnel of T cross-section in the brake lever is provided.

The brake operating device further comprises first and second retaining members each comprising a sleeve and an annular flange. The first and second retaining members are anchored in the other two portions of the tunnel respectively in a spaced manner. The pivot is disposed through the first and second retaining members and the other end of the fastener is secured to an annular groove on an intermediate portion of the pivot.

However, the fastening of the fastener and the pivot may be compromised due to a transverse dislodgement of the pivot. This is because the first and second retaining members are hollow, channel-like members, and factors such as elastic fatigue, wear, etc. adversely affect the normal functions of the pivot after a time of use. Thus, a desired brake by pressing the brake lever toward the handlebar via the pivot, the spring actuated mechanism, and other associated components may not actuate. This can cause danger to a rider. Thus, the need for improvement still exists.

### SUMMARY OF THE INVENTION

It is therefore one object of the invention to provide a brake operating device for a bicycle, comprising a housing mounted on a handlebar and comprising a channel, a first hole, a second hole spaced from the first hole, a bifurcated opening between the first hole and the second hole, a fluid reservoir, and a reservoir cover secured to the fluid reservoir; a spring actuated brake transmission mechanism disposed in the channel; a hydraulic brake lever comprising a stepped-diameter tunnel and a projecting push member proximate to the tunnel, the projecting push member engaging the spring actuated mechanism; and a pivot assembly comprising a first retaining member including a first sleeve disposed in the first hole and having one end engaging the reservoir cover, and an annular first flange at the other end of the first sleeve and engaging an inner surface of the tunnel; a second retaining member including a cup disposed in the second hole and having a bottom through hole, and an annular second flange around mouth of the cup, the second flange engaging the inner surface of the tunnel; and a cylindrical pivot disposed in the first retaining member, the tunnel, and the second retaining member for rotatably supporting the hydraulic brake lever on the housing.

The above and other objects, features and advantages of the invention will become apparent from the following detailed description taken with the accompanying drawings.

### BRIEF DESCRIPTION OF THE DRAWINGS

FIG. 1 is an exploded view of a brake operating device for bicycle according to the invention;

FIG. 2 is an enlarged view of the brake lever, the pivot, and the first and second retaining members of FIG. 1;

FIG. 3 is a perspective view of the assembled pivot and the first and second retaining members of FIG. 1; and

FIG. 4 is a longitudinal sectional view of FIG. 3.

### DETAILED DESCRIPTION OF THE INVENTION

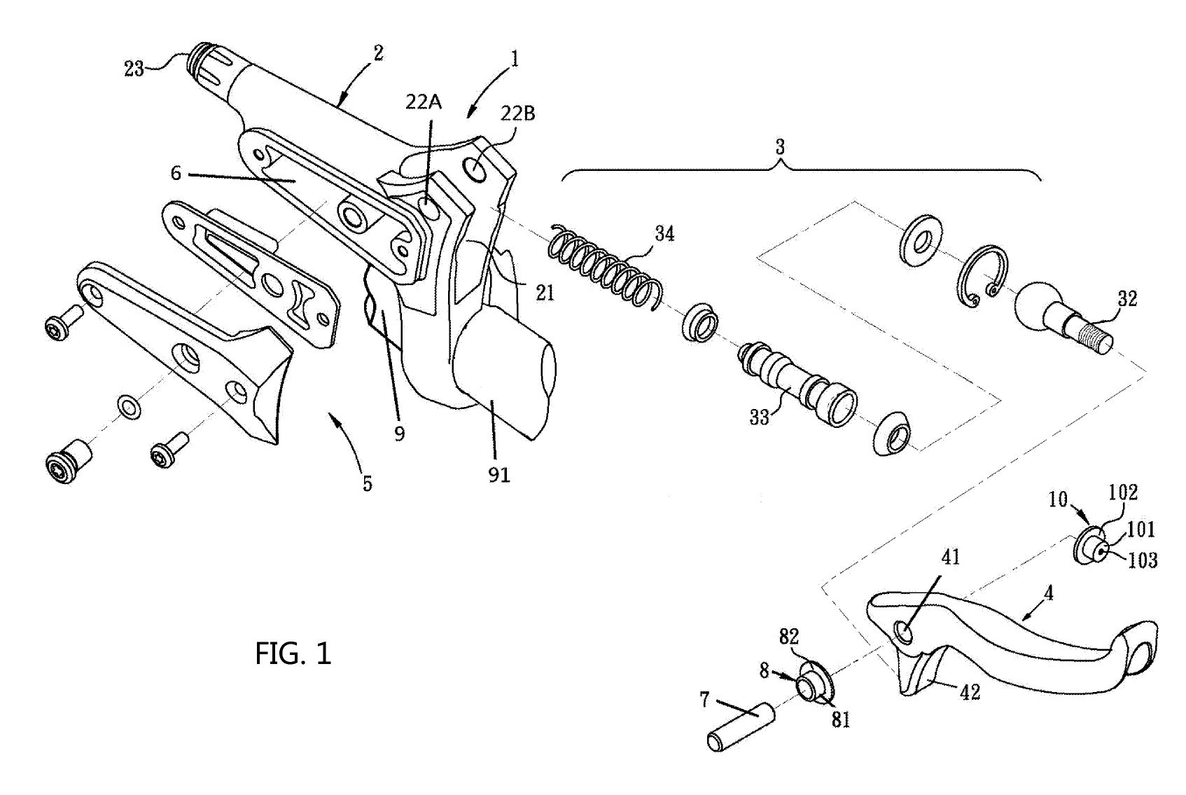

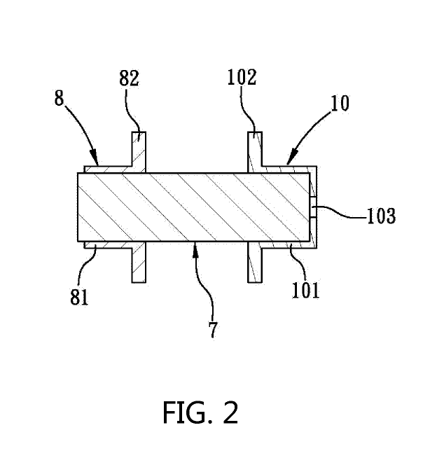

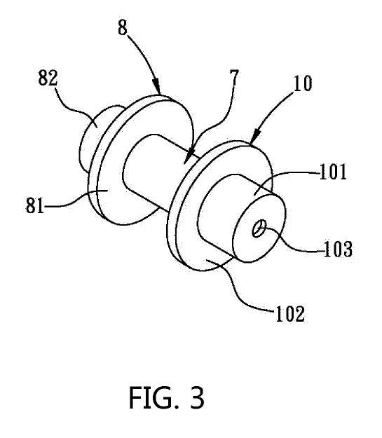

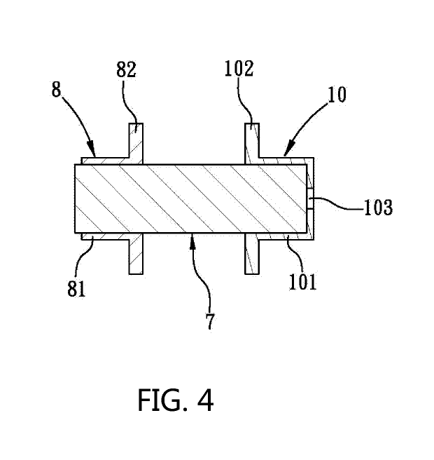

Referring to FIGS. 1 to 4, a brake operating device 1 incorporating a pivot mechanism in a brake lever 4 of bicycle in accordance with the invention is shown and illustrated below.

The brake operating device 1 for bicycles comprises a housing 2 mounted in the vicinity of a grip 91 of a handlebar 9, a hydraulic brake lever 4 rotatably supported on the housing 2 through a cylindrical pivot 7 provided through two opposite first and second holes 22A and 22B spaced by a bifurcated opening 21 as detailed later, a fluid reservoir 6 disposed in the housing 2 and a reservoir cover 5 releasably secured to the fluid reservoir 6.

The brake operating device 1 further comprises a spring actuated brake transmission mechanism 3 provided in a cylindrical channel 23 in the housing 2. The brake transmission mechanism 3 comprises a stepped-diameter piston 33 in a hydraulic cylinder (not shown) which communicates brake fluid with the fluid reservoir 6, two opposite ring members (not numbered) put on the piston 33, a return spring 34 biasing between one end of the piston 33 and an inner surface of the hydraulic cylinder, and a threaded push rod 32 having one end pushing the piston 33 via a C-ring (not numbered) and a washer (not numbered).

The brake lever 4 comprises a stepped-diameter tunnel 41 at one end, the tunnel 41 being disposed between the first and second holes 22A and 22B. A first retaining member 8 comprises a sleeve 81 and an annular flange 82 and disposed in the first hole 22A. Further, the sleeve 81 is disposed in the first hole 22A, the open end of the sleeve 81 engages the reservoir cover 5, and the flange 82 tightly engages the inner surface of the tunnel 41. Thus, the first retaining member 8 is held in place.

The second retaining member 10 comprises a cup 101, an annular flange 102 around the mouth of the cup 101, and a hole 103 through the a center of the bottom of the cup 101. Further, the cup 101 is disposed in the second hole 22B, the outer surface of the cup 101 is flush with the outer surface of the housing 2, and the flange 102 tightly engages the inner surface of the tunnel 41. Thus, the second retaining member 10 is held in place and faces the first retaining member 8 in the tunnel 41.

The pivot 7 can be divided into three portions in which a first portion of the pivot 7 slightly passes the sleeve 81 after disposing in the sleeve 81, a second portion thereof is disposed in the tunnel 41, and a third portion is disposed in the cup 101 and engages the bottom of the cup 101. The pivot 7 is thus held in place.

In a braking operation, a rider may press the brake lever 4 toward the grip 91 to pivot about the pivot 7. And in turn, a push member 42, projecting out of a surface position near the tunnel 41 and engaging the push rod 32, pivots to press the push rod 32. As a result, a wheel brake is actuated via the brake transmission mechanism 3, the brake fluid in the fluid reservoir 6, and other associated components known in the art.

A replacement of the malfunctioned pivot 7 with a new one is discussed below. First, the reservoir cover 5 is required to remove. Next, a rider may use a pointed tool to insert through the hole 103 to push the pivot 7 out of the tunnel 41 prior to the replacement.

It is envisaged by the invention that the pivot 7 can be used for a prolonged period of time without malfunction. Further, it ensures a reliable actuation of the brake.

While the invention has been described in terms of preferred embodiments, those skilled in the art will recognize that the invention can be practiced with modifications within the spirit and scope of the appended claims.

What is claimed is:

1. A brake operating device for a bicycle, comprising:
a housing mounted on a handlebar and comprising a channel, a first hole, a second hole spaced from the first hole, a bifurcated opening between the first hole and the second hole, a fluid reservoir, and a reservoir cover secured to the fluid reservoir;
a spring actuated brake transmission mechanism disposed in the channel;
a hydraulic brake lever comprising a stepped-diameter tunnel and a projecting push member proximate to the tunnel, the projecting push member engaging the spring actuated mechanism; and
a pivot assembly comprising a first retaining member including a first sleeve disposed in the first hole and having one end engaging the reservoir cover, and an annular first flange at the other end of the first sleeve and engaging an inner surface of the tunnel; a second retaining member including a cup disposed in the second hole and having a bottom through hole, and an annular second flange around mouth of the cup, the second flange engaging the inner surface of the tunnel; and a cylindrical pivot disposed in the first retaining member, the tunnel, and the second retaining member for rotatably supporting the hydraulic brake lever on the housing.

2. The brake operating device of claim 1, wherein the reservoir is releasable.

3. The brake operating device of claim 1, wherein an outer surface of bottom of the cup is flush with an outer surface of the housing.
